(19) United States
(12) Patent Application Publication
(10) Pub. No.: US 2006/0003130 A1
(43) Pub. Date: Jan. 5, 2006

(54) Folded edge step mat

(75) Inventor: Lawrence J. O'Connor, Venice, FL (US)

Correspondence Address: ROBERTS, MLOTKOWSKI & HOBBES, P. O. BOX 10064, MCLEAN, VA, 22102, US

(73) Assignee: O'CONNOR INVESTMENT CORP., Winnipeg (CA)

(21) Appl. No.: 11/023,412

(22) Filed: Dec. 29, 2004

Related U.S. Application Data
(63) Continuation-in-part of application No. 10/880,607, filed on Jul. 1, 2004.
(60) Provisional application No. 60/622,047, filed on Oct. 27, 2004.

(51) Int. Cl. B32B 9/00

(52) U.S. Cl. 428/40.1; 428/124; 428/95

(57) ABSTRACT

A covering is provided for exterior application on solid surfaces such as steps, decks, patios, docks, and walkways. The covering is formed of a top layer of fibrous material, such as carpet, and a bottom layer of adhesive applied at a basis weight of between 185-1000 gsm. The adhesive layer may have beads formed on the edges that function as integral gaskets. A release sheet is secured over the adhesive for removal during installation. The covering can be sized for a step and have a pre-folded edge that lays flat against the main covering portion prior to assembly and then conforms to the edge of a step during installation.

### CROSS REFERENCE TO RELATED APPLICATIONS

This application claims priority from U.S. Provisional Application Ser. No. 60/622,047 filed Oct. 27, 2004. This application is a continuation-in-part application of U.S. application Ser. No. 10/880,607 filed Jul. 1, 2004, pending. U.S. application Ser. No. 10/880,607 is (1) a continuation-in-part of U.S. application Ser. No. 10/821,202 filed Apr. 9, 2004 and pending, which claims priority from U.S. Provisional Application Ser. No. 60/536,711 filed Jan. 16, 2004, and (2) a continuation-in-part of U.S. application Ser. No. 10/715,562 filed Nov. 19, 2003 and pending, which claims priority from U.S. Provisional Application Ser. No. 60/491,292 filed Jul. 31, 2003. The contents of these applications are incorporated herein by reference.

### STATEMENT REGARDING FEDERALLY SPONSORED RESEARCH OR DEVELOPMENT

[Not Applicable]

### REFERENCE TO A SEQUENCE LISTING

[Not Applicable]

### BACKGROUND OF THE INVENTION

1. Field of the Invention

This invention relates to surface coverings for exterior use. In particular, this invention relates to coverings used on steps, stairs, decks, patios and walkways.

2. Discussion of Related Art

Door mats are commonly used on stoops to provide a surface at the threshold of an entrance to wipe one's feet. However, most door mats are generally not permanently affixed to a surface. Typically, they are merely placed on the surface or at most have a rubber bottom which provides a friction grip onto the surface.

It is also known to provide coverings, such as indoor/outdoor carpet, on walkways or steps to provide traction on potentially slippery surfaces. Coverings may also be used to refurbish a worn exterior surface rather than full replacement. Again due to the difficulty in affixing coverings to exterior surfaces exposed to the elements, most coverings are merely laid over the surface or tacked in place.

Steps pose a particular problem when using mats or coverings as they receive a concentration of traffic in certain areas and offer an exposed edge, which experiences a high degree of wear and tear. As a result, the edge of a mat on a step often wears down. It can become curled back or otherwise unsecured, which can be unsightly and pose a tripping hazard. To prevent such an exposed edge, trim strips or bullnose strips are often used in conjunction with a step covering. These can be metal or rubber edges that are typically fastened in place with screws to cover and protect the edge of the covering.

There is a need for a covering product that is easy to install, is highly durable and can remain securely fastened in place.

### BRIEF SUMMARY OF THE INVENTION

Aspects of embodiments of the invention relate to a product that provides a durable covering for exterior surfaces.

Another aspect of embodiments of the invention relates to a product that is easy to install and remains securely fastened to an underlying surface.

A further aspect of embodiments of the invention relates to a product that offers a one piece, unitary construction for use on complex surfaces, such as steps.

An additional aspect of embodiments of the invention relates to product that may be efficiently packaged for transport, storage and display.

This invention is directed to fibrous covering for outdoor use having an adhesive coating on the underside for permanent adhesion to an exterior surface. The exterior surface can be a wood or synthetic surface, such as on a deck, or a concrete surface, such as a patio, stoop, walkway, driveway or garage floor. It is contemplated that this covering can be applied to most solid exterior surfaces.

The invention may further include an integral bullnose formed in the fibrous covering. The integral bullnose may be in the form of a pre-folded edge also having an adhesive coating on the underside.

The covering may have a release sheet removably affixed to the adhesive underside for easy installation on site. The pre-folded edge may have separate release sheet. Alternatively, the release sheet may extend over the pre-folded edge or may be a differential release sheet that the pre-folded edge may overlap. Preferably, a separate release sheet is used for the pre-folded edge and a small gap between the main section release sheet and the pre-folded edge release sheet exists to hold the fold in place prior to installation and to provide a positioning mechanism during installation.

One aspect of the invention is directed to a covering to be installed on an exterior surface, comprising a fibrous layer having a top fibrous surface, a bottom surface and a plurality of edges, an adhesive layer applied to the bottom surface of the fibrous layer, and a release sheet removably secured to the adhesive layer. At least a portion of the fibrous layer adjacent one edge is pre-folded to lie flat against at least a portion of the release sheet prior to installation on the exterior surface and to retain an angled shape with respect to the remainder of the fibrous layer during installation.

The fibrous layer may include a mix of low melt polyethylene fibers dispersed within polypropylene fibers.

The adhesive may be a pressure sensitive adhesive.

The adhesive may be applied at a basis weight of between 185-1000 gsm. Preferably, the adhesive is applied at a basis weight of between 300-1000 gsm.

The adhesive may applied at a thickness of between 5-30 mils. Preferably, the adhesive is applied at a thickness of between 15-30 mils.

The adhesive may be formed with a bead adjacent at least one edge of the fibrous layer.

The adhesive may be formed with an integral gasket adjacent at least one edge of the fibrous layer.

The release sheet may cover substantially the entire adhesive layer. More preferably, the release sheet is formed as a main release sheet and an edge release sheet that is disposed under the pre-folded edge. The main release sheet and the edge release sheet can define a gap therebetween that creates an exposed adhesive strip. The exposed adhesive strip can hold the pre-folded edge flat.

The covering may be sized for a step. The covering may be sized for a standard stair tread.

The invention relates to a covering for outdoor use, comprising a carpet layer having a top fibrous surface and a bottom surface and including a main portion and an edge portion, an adhesive layer applied to substantially the entire bottom surface of the carpet layer, and a main release sheet removably secured to the main portion of the carpet layer and an edge release sheet removably secured to the edge portion. A gap is formed between the main release sheet and the edge release sheet that leaves a strip of exposed adhesive. The edge portion of the carpet layer is folded and overlaps the bottom surface of the main portion of the carpet layer with the main release sheet adjacent to the edge release sheet, wherein the exposed adhesive holds the edge portion in the folded position.

These and other aspects of the invention will become apparent when taken in conjunction with the detailed description and appended drawings.

### BRIEF DESCRIPTION OF THE DRAWINGS

The invention will now be described in conjunction with the accompanying drawings in which:

FIG. 1 is front schematic view of a stoop with the covering in accordance with several designs of this invention applied to the surface of steps;

FIG. 2 is an enlarged side view in cross section of a covering in accordance with the invention applied to a step;

FIG. 3 is an enlarged bottom view with the pre-folded edge unfolded showing the adhesive layer of the covering; and

FIG. 4 is an enlarged side view in cross section of a covering in accordance with the invention in a pre-installed state, such as during shipment or display.

In the drawings, like reference numerals indicate corresponding parts in the different figures.

### DETAILED DESCRIPTION OF PREFERRED EMBODIMENTS

This invention is directed to a surface covering in the form of a strip or mat particularly suited for covering a stoop, walkway or steps in an exterior environment or an environment subject to exposure to the elements. The invention is particularly suited for covering steps of typical exterior material, including boards or concrete. These materials tend to have irregular surfaces. For example, boards can exhibit warping and irregularities along their length, and concrete can have cavities, rough aggregate and cracks. The invention may also be used on plastic or plastic composite boards to provide a non-slip surface.

Accordingly, this invention may be used on household decks, docks, walkways, porches, patios, stoops, play sets or other such structures. For purposes of simplicity, the surface used herein is intended to refer to any type of exterior structural surface. The reference to steps also includes any surface having an angled edge that is desirable to finish or cover, such as the edge of a deck or dock.

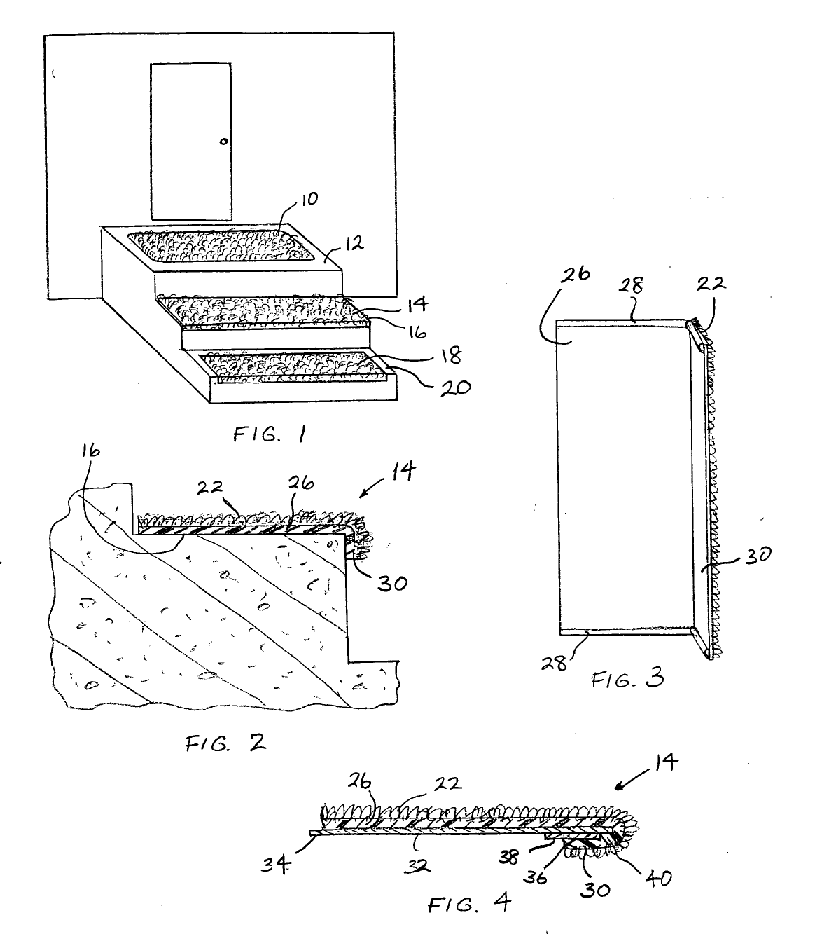

Referring to FIG. 1, a covering 10 is applied to an exterior surface 12, such as a stoop. The top covering 10 is formed as a mat that is permanently affixed to the surface 12. As seen on the lower steps, the covering may be formed as a tread size covering 14 that is secured across substantially the entire surface of the step 16. The covering may also be sized smaller than the tread, as illustrated by covering 18 seen on the lowest step 20. For purposes of simplicity, the configuration of covering 14 is described below. However, it will be understood that the description below is applicable to various configurations of the covering including but not limited to those shown in FIG. 1.

FIG. 2 shows an enlarged view of covering 14 secured to step 16. Covering 14 has a top layer 22 preferably made of a fibrous material, such as carpet material, which provides a top surface with good traction and appearance. A desirable weight of fibers would fall within the range 18-60 ounces per square yard, depending on the particular use and expected traffic. For example, a desirable weight of fibers for a deck may be 18 ounces per square yard, while the desirable weight for a step may be 28 ounces per square yard.

Preferably, the top layer 22 of carpet material is formed as a mix of low melt polyethylene fibers dispersed within polypropylene carpet fibers. The dispersal of these fibers results in a firmer, more stable structure. Due to the improved structure, it is not necessary to use a backing, such as latex as is commonly used. The problem with latex backings in a wet environment is that the foaming agent used during manufacturing becomes reactivated when wet, which causes the material to become slippery. The fiber mix may include UV treated materials to offer increased durability for installations exposed to sunlight.

The underside of the top layer 22 is coated with a thick layer of adhesive 26. Preferably, the adhesive 26 is coated directly onto the backside of the fibrous material to form an integral structure. However, if desired an incompressible layer that can withstand exposure to the elements can be used. Suitable materials for an intermediate layer include foil or EVA film. These materials would provide a tensile strength or barrier layer if desired in the particular design. It is preferred that the back of top layer 22 not be formed of a foam backing layer or a porous material, as is common in interior carpeting, as this tends to become water logged and would disintegrate upon exposure to the elements.

The adhesive 26 is preferably water insoluble to resist deterioration due to the elements. The adhesive layer 26 is preferably made of a pressure sensitive adhesive (PSA) that is a hot melt, meaning it is applied at 100% solids. Suitable adhesive compositions are available from many different manufacturers and can be used as a hot melt adhesive. The application techniques can vary depending on the particular adhesive composition, but one effective method is for the adhesive to be die coated and, if desired, treated with pressure and/or vacuum to enhance physical penetration of the top layer 22. Other suitable methods known to those of ordinary skill in the art are also possible, such as spraying, extrusion, or other methods of coating. It is preferred that hydrophobic adhesive be used to prevent water contaminating the bond between the adhesive and underlying surface.

The viscosity of the adhesive material 26 may also be varied to affect penetration or wetting into the surface 16. Lowering the viscosity, increases the wetability (tack) of the adhesive, thereby allowing it to penetrate deeper into the surface 16. As would be appreciated by those of ordinary skill with adhesives, the density of the adhesive will affect the coating weight. The adhesive material functions as a waterproof layer based on its composition and/or thickness. It is preferred that the material be free of voids.

As noted above, in this invention, the adhesive 26 is applied as a thick layer. The minimum thickness of the adhesive 26 measured to its bottom surface is preferably at least 5 mils so as to provide sufficient thickness of adhesive material to obtain complete coverage to allow molding of the covering 14 to the exposed surface 16. The range of preferred thickness of the adhesive 26 is between about 5 mils and 30 mils, more preferably 15 mils-30 mils. Another method of measuring the adhesive is the applied basis weight, coating weight or amount, as the ultimate thickness can vary depending upon application techniques. The preferred coating weight or amount of adhesive material is at least about 185 gsm, preferably in a range of approximately 185-1000 gsm. These values are based on use of a PSA.

It is contemplated that with different adhesive materials, application techniques, and environments that different volumes, coating weights, or amounts could be successfully used as long as the resultant layer of material has the ability to mold to the irregular surface of the underlying surface to form a permanent bond. For example, it is contemplated that a coating weight of about 100 gsm given the appropriate material could be used, especially in climates that do not experience freeze/thaw cycles. It is also contemplated that in certain applications, strips of moldable material may be used rather than a solid layer.

As a result of the thickness and viscosity, the adhesive 26 also conforms to the surface and forms a mechanical interlock with the underlying surface. This interlock creates a permanent bond that stands up to the exterior elements and forms a very secure bond. This is particularly applicable when used on traditional exterior structural elements such as concrete and wood, which have irregular or non-smooth surfaces. On such surfaces, if the adhesive layer is thin, moisture can penetrate between the adhesive and the surface comprising the connection. Using a thick layer creates the mechanical connection that prevents moisture from penetrating and ensures a secure connection that will be highly durable.

As seen in FIG. 3, the adhesive layer 26 can be provided with a side bead 28 that functions as an integral gasket on the edge. When the covering 14 is pressed onto the surface 16, the bead 28 will tend to flatten and act as a gasket ensuring that no moisture can penetrate the edges of the seal. The bead 28 allows a complete coating of adhesive to be realized under the top layer 22 by spreading to the edges of the top layer 22. Of course, any or all of the edges of the covering 14 may be provided with beads 28.

FIGS. 2-4 show a pre-folded edge 30 formed in the covering 14. The pre-folded edge 30 will retain its shape, as seen in FIG. 3, after being released from the stored condition, seen in FIG. 4. By this, the edge 30 can securely fit over the edge of the surface 16 of a step, as seen in FIG. 2, and be securely retained without a tendency to detach. The edge 30 also provides a built in alignment tool to accurately position the covering 14 over the edge of the step 16. The edge 30 forms an integral bullnose in the covering 14. The pre-folded edge 30 can be made in the covering 14 by any known method, such as pressing the covering 14 through a nip or otherwise applying pressure to form a fold.

FIG. 4 illustrates the covering 14 in a preassembled condition, such as during packaging, transport, storage or display. In this condition, the covering 14 has a release sheet 32 that is releasably applied over the adhesive layer 26. The release sheet 32 is removed during installation and discarded. If desired, the release sheet 32 may carry instructions, measurements, indicia relating to the direction of pile and other printed information. Preferably, the release sheet 32 extends beyond the edges of the covering to form flaps 34 that act as a gripping surface to facilitate removal during installation. The release sheet 32 may be applied as a single sheet or multiple sheets depending on the size of the covering piece.

The pre-folded edge 30 may be covered with the release sheet 32 of the main portion or, in the preferred embodiment, may have its own release sheet 36 with a flap 38 extending outwardly from the outer edge for grasping. The separate edge release sheet 36 may be spaced from the main release sheet 32 by a small gap 40 at the fold. The gap can be about 0.5 inches, for example. This gap 40 will leave a small strip of exposed adhesive 26 that serves several purposes. First, the gap 40 on the pre-folded edge 30 provides an exposed strip of adhesive 26 that adheres to the back of the main release sheet 32 to hold the pre-folded edge 30 in place flat against the main portion of the covering 14. Second, the gap 40 provides an exposed strip of adhesive during installation when the pre-folded edge 30 is unfolded that assists in positioning and tacking the covering 14 in place on the step surface 16. Then, when the proper placement of the covering 14 is achieved, release sheets 32 and 36 can be removed to effect permanent securement.

The release sheet 32, which is also called a release liner, can be formed of any releasable sheet material that is easily pulled from the bottom surface of the adhesive 26. A suitable material is silicone coated polyester film. However, other materials may be used, including films such as high density polyethylene, polypropylene, polyolefin, or silicon coated paper. A preferred material is a silicone coated polyester sheet about 1-2 mils thick. The important features of the sheet 32 are that it releases reliably from the adhesive surface and avoids tearing so that it is easy for an installer to use.

It is also possible to provide the release sheet 32 with a differential release coating on the bottom surface at least where the pre-folded edge 30 overlaps so that the edge 30 may be directly folded against the main release sheet 32 and held in place and then peeled away during installation.

The covering 14 can be provided in any size. For example, covering 10 is formed in a mat size. As a mat, the strip would be held securely in place, which assists in avoiding tripping or when shoveling snow. Coverings 14 and 18 are provided in the general size of a step. For example, for use on a step made of boards, a covering 14 would be made about 6.25 inches with a one inch fold for 2 by 6 inch board. Similarly, covering 14 can be made 10.5 inches with a 1.375-1.5 inch fold for a 2 by 10 inch board and 12.25 inches with a 1/375-1.5 inch fold for a 2 by 12 inch board. The covering 14 can be precut to 3 foot or 4 foot lengths for standard steps. Cutting can be accomplished with a laser for example.

Standard sizes can be prepackaged and simply installed on a step or stoop by a homeowner with no further customization. The release sheet is merely peeled away and the step-sized strip placed on the surface.

It is also possible to provide the covering 14 with the pre-folded edge 30 in a roll, either a pancake roll or traverse wound roll for ease of transport and supply. In that configuration, standard display racks in home improvement retail centers could be used for display and supply.

Various modifications can be made in my invention as described herein, and many different embodiments of the device and method can be made while remaining within the spirit and scope of the invention as defined in the claims without departing from such spirit and scope. It is intended that all matter contained in the accompanying specification shall be interpreted as illustrative only and not in a limiting sense.

What is claimed is:

1. A covering to be installed on an exterior surface, comprising:
a fibrous layer having a top fibrous surface, a bottom surface and a plurality of edges;
an adhesive layer applied to the bottom surface of the fibrous layer; and
a release sheet removably secured to the adhesive layer,
wherein at least a portion of the fibrous layer adjacent one edge is pre-folded to lie flat against at least a portion of the release sheet prior to installation on the exterior surface and to retain an angled shape with respect to the remainder of the fibrous layer during installation.

2. The covering of claim 1, wherein the fibrous layer includes a mix of low melt polyethylene fibers dispersed within polypropylene fibers.

3. The covering of claim 1, wherein the adhesive layer is a pressure sensitive adhesive.

4. The covering of claim 1, wherein the adhesive layer is applied at a basis weight of between 185-1000 gsm.

5. The covering of claim 1, wherein the adhesive layer is applied at a basis weight of between 300-1000 gsm.

6. The covering of claim 1, wherein the adhesive layer is applied at a thickness of between 5-30 mils.

7. The covering of claim 1, wherein the adhesive layer is applied at a thickness of between 15-30 mils.

8. The covering of claim 1, wherein the adhesive layer is formed with a bead adjacent at least one edge of the fibrous layer.

9. The covering of claim 1, wherein the adhesive layer is formed with an integral gasket adjacent at least one edge of the fibrous layer.

10. The covering of claim 1, wherein the release sheet covers substantially the entire adhesive layer.

11. The covering of claim 1, wherein the release sheet is formed as a main release sheet and an edge release sheet that is disposed under the pre-folded edge.

12. The covering of claim 11, wherein the main release sheet and the edge release sheet define a gap therebetween that creates an exposed adhesive strip.

13. The covering of claim 12, wherein the exposed adhesive strip holds the pre-folded edge flat.

14. The covering of claim 1, wherein the covering is sized for a step.

15. The covering of claim 1, wherein the covering is sized for a standard stair tread.

16. A covering for outdoor use, comprising:
a carpet layer having a top fibrous surface and a bottom surface and including a main portion and an edge portion;
an adhesive layer applied to substantially the entire bottom surface of the carpet layer; and
a main release sheet removably secured to the main portion of the carpet layer and an edge release sheet removably secured to the edge portion, wherein a gap is formed between the main release sheet and the edge release sheet that leaves a strip of exposed adhesive,
wherein the edge portion of the carpet layer is folded and overlaps the bottom surface of the main portion of the carpet layer with the main release sheet adjacent to the edge release sheet, wherein the exposed adhesive holds the edge portion in the folded position.

17. The covering of claim 16, wherein the carpet layer includes a mix of low melt polyethylene fibers dispersed within polypropylene fibers.

18. The covering of claim 16, wherein the adhesive layer is formed of a pressure sensitive adhesive.

19. The covering of claim 16, wherein the adhesive layer is applied at a basis weight of between 185-1000 gsm.

20. The covering of claim 16, wherein the adhesive layer is applied at a thickness of between 5-30 mils.

21. The covering of claim 16, wherein the adhesive layer is formed with a bead adjacent at least one edge of the fibrous layer.
